(19) United States
(12) Patent Application Publication
(10) Pub. No.: US 2015/0308646 A1
(43) Pub. Date: Oct. 29, 2015

(54) LIGHT-EMITTING DIODE ARRAY AND LIGHT SOURCE MODULE USING THE SAME

(71) Applicant: WALSIN LIHWA CORPORATION, Yangmei City (TW)

(72) Inventors: Chang-Ho Chen, Yangmei City (TW); Hsueh-Lung Chen, Yangmei City (TW); TSUNG-JEN TENG, Yangmei City (TW); Yen-Ting Lin, Yangmei City (TW)

(73) Assignee: WALSIN LIHWA CORPORATION, Yangmei City (TW)

(21) Appl. No.: 14/664,306

(22) Filed: Mar. 20, 2015

Related U.S. Application Data
(60) Provisional application No. 61/969,441, filed on Mar. 24, 2014.

(30) Foreign Application Priority Data
Oct. 6, 2014 (TW) 103134681

(51) Int. Cl. F21S 8/10

(52) U.S. Cl. CPC F21S 48/1747; F21S 48/115; F21S 48/1104; F21Y 2105/001

(57) ABSTRACT

A light source module comprising a substrate and a light-emitting diode (LED) array is provided. The LED array comprises a first LED sub-array, a second LED sub-array, and a third LED sub-array disposed on the substrate along a horizontal axis. The first LED sub-array is configured to emit a first light beam. The second LED sub-array is configured to emit a second light beam. The third LED sub-array disposed between the first and second LED sub-arrays is configured to emit a third light beam. The first, second, and third light beams jointly forms a light area. Luminance of the third light beam is less than luminance of the first light beam or luminance of the second light beam.

### CROSS-REFERENCES TO RELATED APPLICATIONS

This application claims the benefit of Provisional Application Ser. No. 61/969,441 filed on Mar. 24, 2014.

This application claims the benefit of priority based on Taiwan Patent Application No 103134681, filed on Oct. 6, 2014, the contents of which are incorporated herein by reference in their entirety.

### BACKGROUND OF THE INVENTION

1. Field of the Invention

The present invention is related to a light source module and a light-emitting diode (LED) array for the light source module; and more particularly, the present invention is related to an LED array for a light source module and a light source module complying with vehicle lighting regulations.

2. Descriptions of the Related Art

Headlights in motor vehicles are mainly used at night or in harsh environments for road lighting. In conventional vehicle headlights, halogen lamps or high intensity discharge (HID) lamps are commonly provided as the light source. In an HID lamp, light is generated by a discharge phenomenon that occurs between two metal electrodes respectively disposed at both ends of the HID lamp. Thus, compared to halogen lamps, HID lamps have higher lumen output, better luminous efficacy, and longer lifetime. However, the lifetime of an HID lamp is generally only several hundred or several thousand hours. Therefore, seeking a new durable light source to replace conventional lamps for higher lumen output, better luminous efficacy, and longer lifetime is a need for new motor vehicles.

With the development of integrated circuit (IC) design, semiconductor manufacturing, and photovoltaic technology, LED is a new type of solid-state light source in the 21st century. Compared to halogen lamps or HID lamps, LED lamps have smaller size, higher lumen output, better luminous efficacy, lower power consumption, and longer lifetime. However, the optical, the thermal, and the electrical designs of new LED lamps are different from those of halogen lamps or HID lamps. Automobile manufacturers have to reconsider different design rules for headlights with LED lamps during developing new motor vehicles. For example, the detailed designs of an LED headlight complying with vehicle lighting regulations are shown and described in U.S. Pat. No. 7,645,062, filed on Mar. 25, 2004 and entitled “Light Source and Vehicle Lamp.”

Moreover, as to existing motor vehicles having conventional headlights with halogen lamps or HID lamps, it is hard to directly utilize an LED lamp of a new headlight to replace a halogen lamp or an HID lamp of an original headlight due to different architectures between the original headlight and the new headlight. As a result, consumers will attenuate will of replacing the halogen lamp or the HID lamp with the LED lamp.

In view of this, it is important to provide an LED light source which can directly replace a light source of a halogen lamp or an HID lamp, such that the consumer can replace the light source of the halogen lamp or the HID lamp with the LED light source rapidly and precisely.

### SUMMARY OF THE INVENTION

An objective of the present invention is to provide an LED array for a light source module. The light source module comprises a substrate.

To achieve the aforesaid objective, the LED array of the present invention comprises a first LED sub-array, at least one second LED sub-array, and at least one third LED sub-array. The first LED sub-array emits a first light beam. The at least one second LED sub-array emits a second light beam. The at least one third LED sub-array is disposed between the first LED sub-array and the at least one second LED sub-array, and emits a third light beam. The first LED sub-array, the at least one second LED sub-array, and the at least one third LED sub-array are substantially disposed on the substrate along a horizontal axis. The first light beam, the second light beam, and the third light beam jointly form a light area. Luminance of the third light beam is less than luminance of the first light beam or luminance of the second light beam.

Another objective of the present invention is to provide a light source module which comprises a substrate and an LED array. The LED array has a plurality of LED chips. The LED chips are substantially disposed on the substrate along a horizontal axis. Distances between each two adjacent LED chips of the LED array are substantially different from each other.

Yet a further objective of the present invention is to provide a light source module which comprises a substrate and an LED array. The LED array is disposed on the substrate and emits a light beam for forming a light area. The light area has an effective horizontal width which is substantially from 6 millimeter (mm) to 18 mm.

Another further objective of the present invention is to provide a light source module which comprises a substrate, an LED array, and a protruding structure. The protruding structure is disposed on the substrate and surrounding the LED array. The LED array is disposed on the substrate and emits a light beam forming a non-rectangular light area via the protruding structure.

According to the above description, the light source module and the LED array for the light source module according to the present invention provide a light source complying with vehicle lighting regulations and architectures of original headlights in motor vehicles. Accordingly, the light source module and the LED array for the light source module according to the present invention can effectively overcome the problem of the prior art that, consumers will attenuate will of replacing the halogen lamp or the HID lamp with the LED lamp.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an illumination device for a vehicle headlight;

FIG. 2 is a schematic view of one embodiment of a light source module;

FIG. 3 is a sectional view of one embodiment of a light source module;

FIG. 4 is a schematic view of an illumination area formed on a projection plane by one embodiment of a light source module;

FIG. 5 is a schematic view of one embodiment of a light source module;

FIG. 6 is a schematic view of one embodiment of a light source module; and

FIG. 7 is a schematic view of one embodiment of a light source module.

### DESCRIPTION OF THE PREFERRED EMBODIMENT

In the following description, this invention will be explained with reference to embodiments thereof. However, the description of these embodiments is only for purposes of illustration rather than limitation. It should be appreciated that in the following embodiments and attached drawings, elements unrelated to this invention are omitted from depictions; and dimensional relationships among individual elements in the attached drawings are illustrated only for ease of understanding, but not to limit the actual scale.

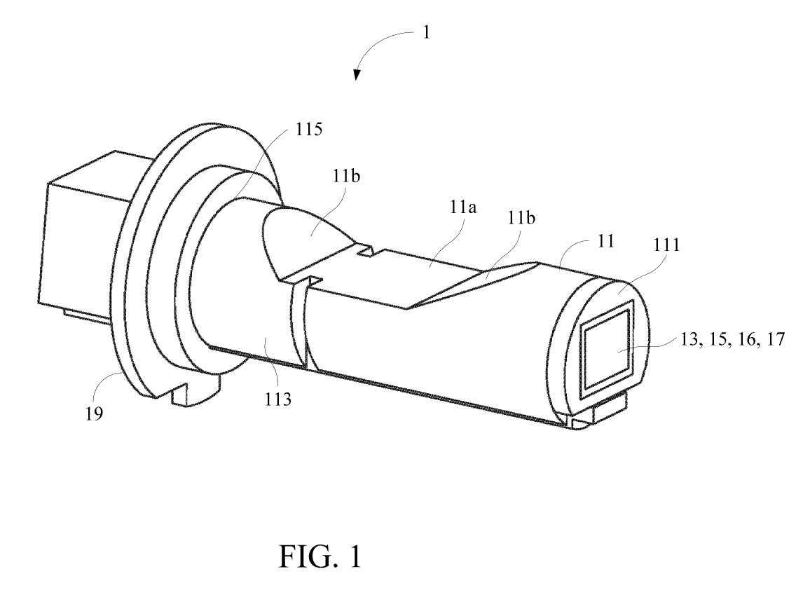

FIG. 1 depicts an illumination device 1 for a vehicle headlight. The illumination device 1 has a column 11, a light source module 13, 15, 16, 17, and a fixing part 19. The illumination device 1 is fixed in the vehicle headlight by the fixing part 19. The column 11 has a front end 111, a side 113, and a back end 115 opposite to the front end 111. The side 113 has a groove having a bottom 11a and two sidewalls 11b. The fixing part 19 is disposed near the back end 115 of the column 11. In one embodiment, the column 11 is a cylinder having a side 113. However, in other embodiments, the column 11 can be a column, such as, a cuboid, having a plurality of sides. It should be noted that the column 11 is not limited to be a cylinder having a side 113 in the embodiment. The vehicle headlight has a control circuit module (not shown) which is electrically connected to the illumination device 1. The control circuit module controls a switch of the light source module 13. More specifically, the light source module 13 emits a light beam (not shown) according to a control of the control circuit module of the vehicle headlight. The light beam forms an illumination area complying with asymmetrical beam illumination regulations (i.e. ECE R112) on a projection plane with a distance of 25 meters ahead of the vehicle headlight.

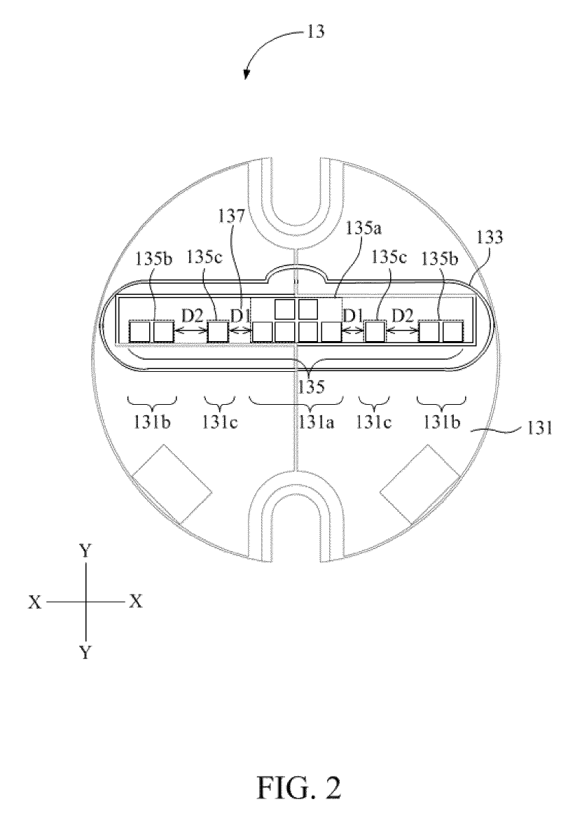

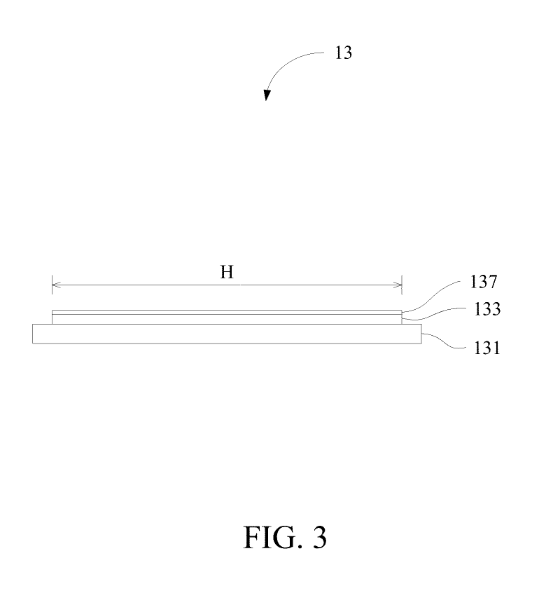

FIG. 2 and FIG. 3 respectively depict the schematic view and the sectional view of the light source module 13 of one embodiment. The light source module 13 has a substrate 131, a protruding structure 133, an LED array 135, and a fluorescent layer 137. The substrate 131 has a central area 131a, two side areas 131b, and two third areas 131c. Each of the third areas 131c is disposed between each of the side areas 131b and the central area 131a. The LED array 135 disposed on the substrate 131 has a first LED sub-array 135a, two second LED sub-arrays 135b, and two third LED sub-arrays 135c.

In one embodiment, the substrate 131 is made of heat conductive material for increasing cooling efficiency of the LED array 135. For example, the substrate 131 can be made of aluminum, copper, lead, tin, magnesium, zinc, steel, titanium, polymer, ceramic, or a combination of the aforesaid materials. The LED array 135 is made by chip-on-board (COB) package process. The detailed technical information of the LED package process can be referred to U.S. Pat. No. 7,732,233, filed on Jun. 10, 2009 and entitled “Method for making light emitting diode chip package,” and U.S. Pat. No. 8,129,206, filed on Jun. 9, 2009 and entitled “Light emitting diode package and method of making the same,” which are herein incorporated by reference.

More specifically, the first LED sub-array 135a disposed on the central area 131a of the substrate 131 emits a first light beam (not shown). The second LED sub-arrays 135b are respectively disposed on the side areas 131b of the substrate 131. Each of the second LED sub-arrays 135b emits a second light beam (not shown). The third LED sub-arrays 135c are respectively disposed on the third areas 131c of the substrate 131. Each of the third LED sub-arrays 135c emits a third light beam (not shown). The first LED sub-array 135a, the second LED sub-arrays 135b, and the third LED sub-arrays 135c are substantially disposed on the substrate 131 along a horizontal axis X.

As shown in FIG. 3, the first LED sub-array 135a has a plurality of LED chips substantially symmetrically disposed on the central area 131a of the substrate 131 along the horizontal axis X and a vertical axis Y. Each of the second LED sub-arrays 135b has a plurality of LED chips substantially symmetrically disposed on each of the side areas 131b of the substrate 131 along the horizontal axis X. Each of the third LED sub-arrays 135c has an LED chip disposed on each of the third areas 131c of the substrate 131. In other words, the LED chip of each of the third LED sub-arrays 135c is disposed between LED chips of each of the second LED sub-arrays 135b and LED chips of the first LED sub-array 135a.

The LED chip can be a horizontal-type LED chip, a vertical LED chip, or a flip LED chip. In one embodiment, the first LED sub-array 135a has six LED chips. Each of the second LED sub-arrays 135b has two LED chips. Each of the third LED sub-arrays 135c has a LED chip. However, in other embodiments, the first LED sub-array 135a, the second LED sub-arrays 135b, and the third LED sub-arrays 135c can individually have different number of LED chip. It should be noted that the first LED sub-array 135a is not limited to have six LED chips in the embodiment. Similarly, it should be noted that each of the second LED sub-arrays 135b is not limited to have two LED chips in the embodiment. It should be also noted that each of the third LED sub-arrays 135c is not limited to have a LED chip. Each of the LED chips of the first LED sub-array 135a, the second LED sub-arrays 135b, and the third LED sub-arrays 135c has an area. The areas of the LED chips are approximately the same.

Accordingly, luminance of the third light beam emitted by one of the third LED sub-arrays 135c is less than luminance of the first light beam emitted by the first LED sub-array 135a or luminance of the second light beam emitted by one of the second LED sub-arrays 135b.

There is a first distance D1 between the first LED sub-array 135a and the third LED sub-array 135c next to the first LED sub-array 135a. There is a second distance D2 between the second LED sub-array 135b and the third LED sub-array 135c next to the second LED sub-array 135b. Accordingly, there is the first distance D1 between the LED chip of the first LED sub-array 135a and the LED chip of the third LED sub-array 135c next to the LED chip of the first LED sub-array 135a. There is the second distance D2 between the LED chip of the second LED sub-array 135b and the LED chip of the third LED sub-array 135c next to the LED chip of the second LED sub-array 135b. In one embodiment, the first distance D1 or the second distance D2 is substantially from 50 micrometer (μm) to 900 μm. The second distance D2 is greater than the first distance D1. However, in other embodiments, the second distance D2 can be less than or equal to the first distance D1. It should be noted that the second distance D2 is not limited to be greater than the first distance D1.

More specifically, each of the distances between each two adjacent LED chips of the first LED sub-array 135a is substantially from 50 μm to 150 μm. Similarly, each of the distances between each two adjacent LED chips of each of the second LED sub-arrays 135b is substantially from 50 μm to 150 μm. In one embodiment, the distances between each two adjacent LED chips of the first LED sub-array 135a or each of the second LED sub-arrays 135b are less than the first distance D1 or the second distance D2.

The protruding structure 133 which surrounds the LED array 135 is used for supporting the fluorescent layer 137. The protruding structure 133 has a height substantially from 0.5 mm to 1.5 mm. Accordingly, the fluorescent layer 137 disposed on the LED array 135 has an effective horizontal width H substantially from 6 mm to 18 mm. The first light beam emitted by the first LED sub-array 135a, the second light beams emitted by the second LED sub-arrays 135b, and the light beams emitted by the third LED sub-arrays 135c are mixed through the fluorescent layer 137 to form the aforesaid light beam emitted by the light source module 13. The light beam emitted by the light source module 13 mixed by the first light beam, the second light beams, and the third light beams forms a light area with the effective horizontal width H substantially from 6 mm to 18 mm according to a shape of the protruding structure 133 and a shape of the fluorescent layer 137 corresponding to the shape of the protruding structure 133.

In one embodiment, the light beam emitted by the light source module 13 mixed by the first light beam, the second light beams, and the third light beams forms a non-rectangular light area according to the shape of the protruding structure 133 and the shape of the fluorescent layer 137. However, in other embodiments, the light beam emitted by the light source module 13 mixed by the first light beam, the second light beams, and the third light beams can form different kinds of light areas according to different shapes of the protruding structure 133 and the fluorescent layer 137. It should be noted that the light area formed by the light beam is not limited to be a non-rectangular light area.

According to the above description, the LED array 135 of the light source module 13 has the light area with the effective horizontal width H substantially from 6 mm to 18 mm. The light area of the LED array 135 of the light source module 13 has a central area, two side areas, and two third areas respectively corresponding to the central area 131a, the side areas 131b, and the third areas 131c of the substrate 131. More specifically, the first light beam emitted by the first LED sub-array 135a of the LED array 135 forms the central area of the light area. The second light beams emitted by the second LED sub-arrays 135b respectively form the side areas of the light area. The third light beams emitted by the third LED sub-arrays 135c respectively form the third areas of the light area.

According to the above description, the luminance of the third light beam emitted by one of the third LED sub-arrays 135c is less than the luminance of the first light beam emitted by the first LED sub-array 135a or the luminance of the second light beam emitted by one of the second LED sub-arrays 135b. Thus, luminance of the central area of the light area is greater than luminance of one of the third areas of the light area. Luminance of one of the side areas of the light area is greater than the luminance of one of the third areas of the light area.

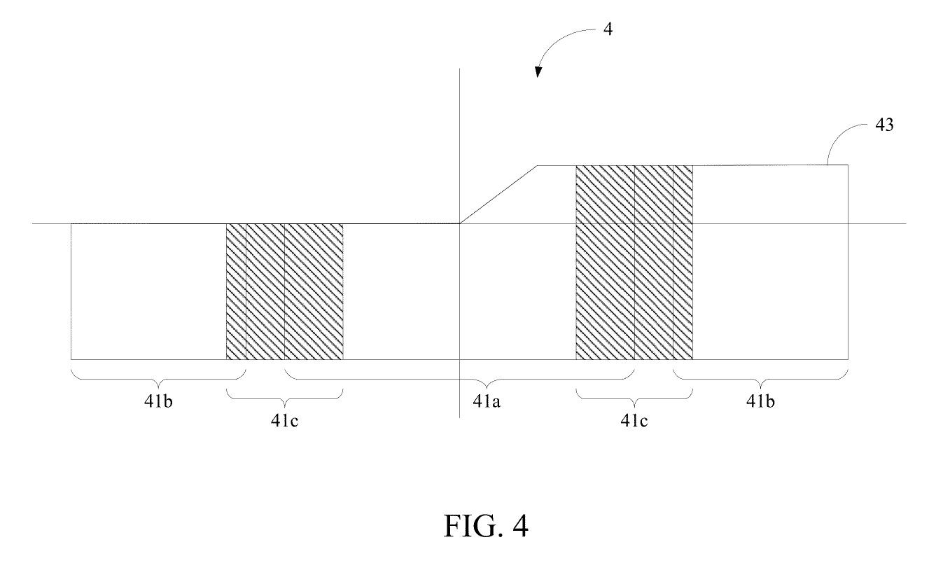

As shown in FIG. 4, an illumination area 4 is formed on the projection plane with the distance of 25 meters ahead of the vehicle headlight by the light area of the LED array 135 of the light source module 13. The illumination area 4 has a cut-off line 43 for complying with asymmetrical beam illumination regulations (i.e. ECE R112) because a shutter of the vehicle headlight partly shields the light area of the LED array 135.

More specifically, the central area of the light area formed by the first LED sub-array 135a forms a central illumination area 41a of the illumination area 4 on the projection plane with the distance of 25 meters ahead of the vehicle headlight through the shutter. The side areas of the light area formed by the second LED sub-arrays 135b respectively form two side illumination areas 41b of the illumination area 4 on the projection plane with the distance of 25 meters ahead of the vehicle headlight through the shutter. The third areas of the light area formed by the third LED sub-arrays 135c respectively form two third illumination areas 41c of the illumination area 4 on the projection plane with the distance of 25 meters ahead of the vehicle headlight through the shutter. The third illumination areas 41c partly individually overlap the central illumination area 41a. Simultaneously, the third illumination areas 41c partly respectively overlap the side illumination areas 41b.

According to the above description, the luminance of the central area of the light area or the luminance of one of the side areas of the light area is greater than the luminance of one of the third areas of the light area. A number of the LED chips of the first LED sub-array 135a is greater than a number of the LED chips of one of the second LED sub-arrays 135b or a number of the LED chips of one of the third LED sub-arrays 135c. The number of the LED chips of one of the second LED sub-arrays 135b is greater than the number of the LED chips of one of the third LED sub-arrays 135c. Thus, luminance of the central illumination area 41a is greater than luminance of one of the third illumination areas 41c. Luminance of one of the side illumination areas 41b is greater than the luminance of one of the third illumination areas 41c. An area of the central illumination area 41a is greater than an area of one of the third illumination areas 41c. An area of one of the side illumination areas 41b is greater than the area of one of the third illumination areas 41c.

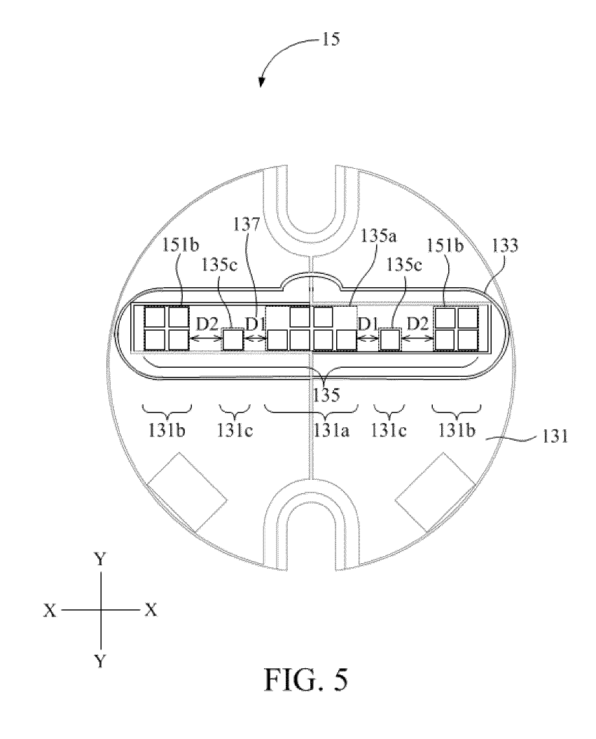

FIG. 5 depicts the schematic view of the light source module 15 of one embodiment. The light source module 15 being approximately the same as the light source module 13 has a substrate 131, a protruding structure 133, an LED array 135, and a fluorescent layer 137. The substrate 131 has a central area 131a, two side areas 131b, and two third areas 131c. Each of the third areas 131c is disposed between each of the side areas 131b and the central area 131a. The LED array 135 disposed on the substrate 131 has a first LED sub-array 135a, two second LED sub-arrays 151b, and two third LED sub-arrays 135c.

Each of the second LED sub-arrays 151b has four LED chips substantially symmetrically disposed on each of the side areas 131b of the substrate 131 along the horizontal axis X and the vertical axis Y. Luminance of a second light beam emitted by one of the second LED sub-arrays 151b of the light source module 15 is greater than the luminance of the second light beam emitted by one of the second LED sub-arrays 135b of the light source module 13 due to increasing a number of the LED chips.

In addition to the aforesaid description, the embodiment of the light source module 15 can also execute all the operations and functions set forth in the embodiment light source module 13. How the light source module 15 executes these operations and functions will be readily appreciated by those of ordinary skill in the art based on the explanation of the light source module 13 and, thus, will not be further described herein.

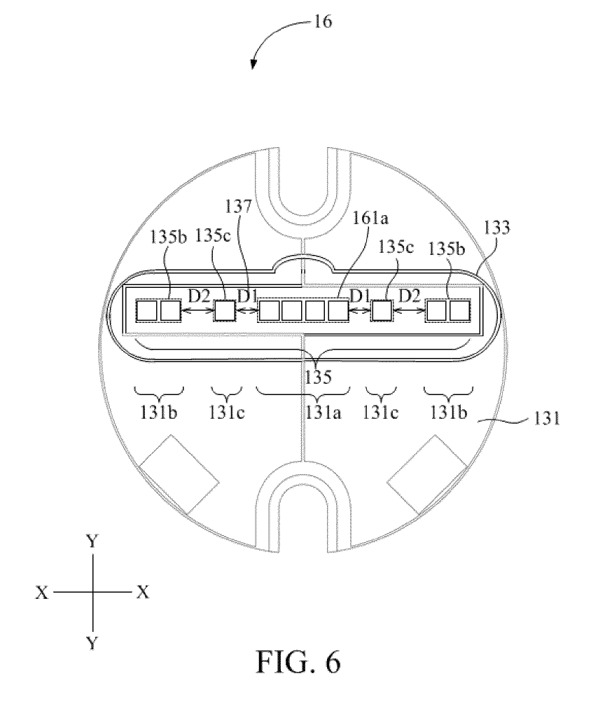

FIG. 6 depicts the schematic view of the light source module 16 of one embodiment. The light source module 16 being approximately the same as the light source module 13 has a substrate 131, a protruding structure 133, an LED array 135, and a fluorescent layer 137. The substrate 131 has a central area 131a, two side areas 131b, and two third areas 131c. Each of the third areas 131c is disposed between each of the side areas 131b and the central area 131a. The LED array 135 disposed on the substrate 131 has a first LED sub-array 161a, two second LED sub-arrays 135b, and two third LED sub-arrays 135c.

The first LED sub-arrays 161a has four LED chips substantially symmetrically disposed on the central areas 131a of the substrate 131 along the horizontal axis X. Manufacturing cost of the light source module 16 is less than manufacturing cost of the light source module 13 due to decreasing a number of the LED chips.

In addition to the aforesaid description, the embodiment of the light source module 16 can also execute all the operations and functions set forth in the embodiment light source module 13. How the light source module 16 executes these operations and functions will be readily appreciated by those of ordinary skill in the art based on the explanation of the light source module 13 and, thus, will not be further described herein.

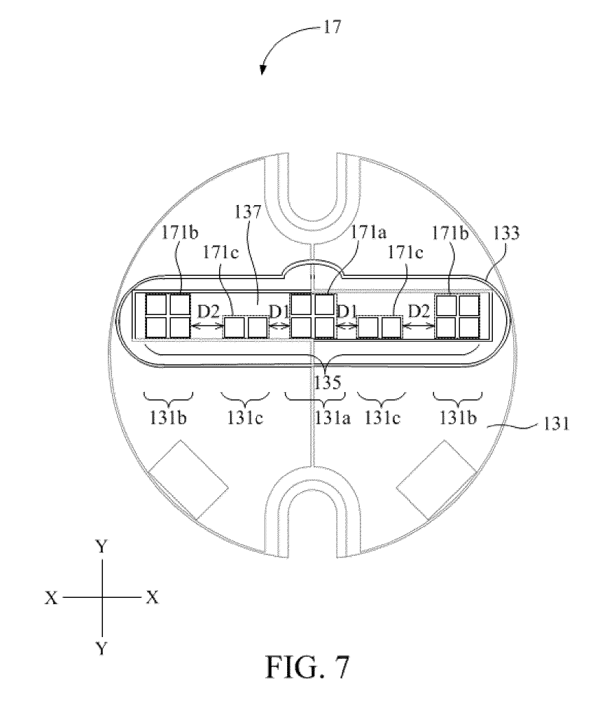

FIG. 7 depicts the schematic view of the light source module 17 of one embodiment. The light source module 17 being approximately the same as the light source module 13 has a substrate 131, a protruding structure 133, an LED array 135, and a fluorescent layer 137. The substrate 131 has a central area 131a, two side areas 131b, and two third areas 131c. Each of the third areas 131c is disposed between each of the side areas 131b and the central area 131a. The LED array 135 disposed on the substrate 131 has a first LED sub-array 171a, two second LED sub-arrays 171b, and two third LED sub-arrays 171c.

The first LED sub-array 171a has four LED chips substantially symmetrically disposed on the central area 131a of the substrate 131 along the horizontal axis X and the vertical axis Y. Each of the second LED sub-arrays 171b has four LED chips substantially symmetrically disposed on each of the side areas 131b of the substrate 131 along the horizontal axis X and the vertical axis Y. Each of the third LED sub-arrays 171c has two LED chips substantially symmetrically disposed on each of the third areas 131c of the substrate 131 along the horizontal axis X. A light source quality of the light source module 17 is better than a light source quality of the light source module 13 due to averaging a number of the LED chips between the first LED sub-array 171a, the second LED sub-arrays 171b, and the third LED sub-arrays 171c.

In addition to the aforesaid description, the embodiment of the light source module 17 can also execute all the operations and functions set forth in the embodiment light source module 13. How the light source module 17 executes these operations and functions will be readily appreciated by those of ordinary skill in the art based on the explanation of the light source module 13 and, thus, will not be further described herein.

The LED array 135 can be disposed on the substrate 131 in a specific pattern, for example, but not limited to, an L shape, an U shape, an H shape, an M shape, an N shape, or a ⊥ shape according to different arrangements of the first LED sub-arrays 135a, 161a, 171a, the second LED sub-arrays 135b, 151b, 171b, and the third LED sub-arrays 135c, 171c. The detailed designs of the LED arrays can be referred to U.S. Design patent application No. 29/471,507, filed on Nov. 1, 2013 and entitled “Light Emitting Diode Device,” China Design patent application No. 201330532498.2, filed on Nov. 7, 2013 and entitled “Light Emitting Diode Device,” and Taiwan Design patent application No. 103301434, filed on Mar. 14, 2014 and entitled “Portion of Light Emitting Diode Device,” which are herein incorporated by reference.

According to the above description, the light source module and the LED array for the light source module provide a light source complying with vehicle lighting regulations and architectures of original headlights in motor vehicles. Accordingly, the light source module and the LED array for the light source module according to the present invention can effectively overcome the problem of the prior art that, consumers will attenuate will of replacing the halogen lamp or the HID lamp with the LED lamp.

The above embodiments merely give the detailed technical contents of the present invention and inventive features thereof, and are not to limit the covered range of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A light-emitting diode (LED) array for a light source module, the light source module comprising a substrate, the LED array comprising:
a first LED sub-array being configured to emit a first light beam;
at least one second LED sub-array being configured to emit a second light beam; and
at least one third LED sub-array, disposed between the first LED sub-array and the at least one second LED sub-array, being configured to emit a third light beam;
wherein the first LED sub-array, the at least one second LED sub-array, and the at least one third LED sub-array are substantially disposed on the substrate along a horizontal axis, the first light beam, the second light beam, and the third light beam jointly form a light area, and luminance of the third light beam is less than one of luminance of the first light beam and luminance of the second light beam.

2. The LED array as claimed in claim 1, wherein the first LED sub-array has a plurality of LED chips substantially symmetrically disposed on a central area of the substrate along the horizontal axis.

3. The LED array as claimed in claim 2, wherein each of distances between each two adjacent LED chips is substantially from 50 micrometer (μm) to 900 μm.

4. The LED array as claimed in claim 3, wherein each of the distances between each two adjacent LED chips is substantially from 50 μm to 150 μm.

5. The LED array as claimed in claim 2, wherein each of the LED chips has an area, and the areas of the LED chips are approximately the same.

6. The LED array as claimed in claim 2, wherein the LED chips substantially symmetrically disposed on the substrate along a vertical axis.

7. The LED array as claimed in claim 2, wherein a distance between the first LED sub-array and the at least one third LED sub-array is greater than each of distances between each two adjacent LED chips of the first LED sub-array.

8. The LED array as claimed in claim 1, wherein the at least one second LED sub-array has a plurality of LED chips substantially symmetrically disposed on at least one side area of the substrate along the horizontal axis.

9. The LED array as claimed in claim 8, wherein each of distances between each two adjacent LED chips is substantially from 50 μm to 900 μm.

10. The LED array as claimed in claim 9, wherein each of the distances between each two adjacent LED chips is substantially from 50 μm to 150 μm.

11. The LED array as claimed in claim 8, wherein each of the LED chips has an area, and the areas of the LED chips are approximately the same.

12. The LED array as claimed in claim 8, wherein the LED chips substantially symmetrically disposed on the substrate along a vertical axis.

13. The LED array as claimed in claim 8, wherein a distance between the at least one second LED sub-array and the at least one third LED sub-array is greater than each of distances between each two adjacent LED chips of the at least one second LED sub-array.

14. The LED array as claimed in claim 1, wherein the light area has an effective horizontal width being substantially from 6 millimeter (mm) to 18 mm.

15. A light source module, comprising:
a substrate; and
an LED array having a plurality of LED chips, wherein the LED chips are substantially disposed on the substrate along a horizontal axis;
wherein distances between each two adjacent LED chips of the LED array are substantially different from each other.

16. The light source module as claimed in claim 15, wherein each of the distances between each two adjacent LED chips is substantially from 50 μm to 900 μm.

17. The light source module as claimed in claim 16, wherein each of the distances between each two adjacent LED chips is substantially from 50 μm to 150 μm.

18. The light source module as claimed in claim 15, wherein the LED chips jointly form a light area on the substrate, the light area comprises a central area, at least one side area, and a third area disposed between the central area and the at least one side area, luminance of the central area or luminance of the at least one side area is greater than luminance of the third area.

19. A light source module, comprising:
a substrate; and
an LED array, disposed on the substrate, being configured to emit a light beam for forming a light area;
wherein the light area has an effective horizontal width being substantially from 6 mm to 18 mm.

20. A light source module, comprising:
a substrate;
an LED array, disposed on the substrate, being configured to emit a light beam; and
a protruding structure, disposed on the substrate, being configured for surrounding the LED array;
wherein the light beam forms a non-rectangular light area via the protruding structure.

21. The light source module as claimed in claim 20, further comprising a fluorescent layer disposed on the LED array via the protruding structure, wherein the light beam forms the non-rectangular light area via the protruding structure and the fluorescent layer.

22. The light source module as claimed in claim 20, wherein the protruding structure has a height being substantially from 0.5 mm to 1.5 mm.
